(19) United States
(12) Patent Application Publication
(10) Pub. No.: US 2017/0063554 A1
(43) Pub. Date: Mar. 2, 2017

(54) METHOD AND DEVICE FOR MULTI-USER CLUSTER IDENTITY AUTHENTICATION

(71) Applicant: Alibaba Group Holding Limited, Georgetown (KY)

(72) Inventors: Kaige AN, Hangzhou (CN); Yeqi YING, Hangzhou (CN); Yijun LU, Hangzhou (CN)

(21) Appl. No.: 15/245,690

(22) Filed: Aug. 24, 2016

(30) Foreign Application Priority Data
Aug. 25, 2015 (CN) 201510526904.2

(51) Int. Cl. H04L 9/32; H04L 9/30; H04L 29/06; H04L 9/14

(52) U.S. Cl. CPC H04L 9/3247; H04L 9/14; H04L 9/30; H04L 63/06

(57) ABSTRACT

Embodiments of the present invention provide methods and devices for multi-user cluster identity authentication, where a key set of a user cluster device is managed using a processor, the key set and an identification code of the key set are distributed to the user cluster device, and when the user cluster device makes a request to access a certain service device, an authentication request is sent to a key management device that includes a digital signature of the user cluster device. The key management device performs identity authentication on the user cluster device, regularly updates the key set and the identification code of the key set using a polling mechanism, and distributes the key set and the identification code to the user cluster device. The user cluster device updates the digital signature using the updated key set and the identification code.

### CROSS-REFERENCE TO RELATED APPLICATIONS

This application claims priority to Chinese Patent Application No. 201510526904.2, filed on Aug. 25, 2015, which is incorporated herein by reference in its entirety.

### TECHNICAL FIELD

Embodiments of the present application relate to the field of information security, and in particular, to methods and devices for providing multi-user identity authentication.

### BACKGROUND

As cloud computing advances, service-oriented processes are also gradually expanding. Managing service-oriented access permissions for users is a technical challenge, especially for situations where cloud services provide several service-oriented processes at once.

Currently, when each user cluster has a dedicated service module, the action scope of the service module is used to identify a user. However, this technique only works for the current cluster.

Existing approaches to verifying access permissions mainly include providing a key to a server, and sending a request with corresponding identity information to a service-oriented node (e.g., a device that provides a service). The key is processed, and the service-oriented node completes/authenticates the access.

However, as the service-oriented use of various modules has advanced, multiple user clusters may share one service module. Further, the signature information of an access may be intercepted during a network transmission, and the user's signature information may be cracked or otherwise compromised. In some cases, user identity authentication information may remain unchanged for a long time, which leads to a high leakage risk. The efficiency of verification processes in an OpenSSL (Open Secure Sockets Layer) protocol is not high for a large-scale distributed environment, and performing authentication using a service-oriented node increases the load of the service-oriented node.

Therefore, there is a great need to be able to complete authentication on multiple user clusters of the same service-oriented node to support access for the multiple user clusters.

### SUMMARY

Embodiments of the present invention describe methods and devices for performing identity authentication on one or more user clusters in response to a request to access a service device from the user cluster or clusters.

According to one embodiment, a method of multi-user cluster identity authentication using a key management device is described. The method includes distributing a key set and an identification code corresponding to the key set to a user cluster device, where the key set includes a plurality of pairs of public keys and private keys, acquiring an authentication request sent by the service device, performing identity authentication on the user cluster device based on a digital signature of the user cluster device in the authentication request, and returning an authentication result to the service device, where the digital signature includes an identification code of the user cluster device, and cluster verification information encrypted using the private keys.

According to another embodiment, a method of multi-user cluster identity authentication is disclosed. The method includes acquiring an access request from a user cluster device, where the access request includes a digital signature of the user cluster device, the digital signature includes an identification code, and cluster verification information encrypted using a private key of a key set, sending an authentication request to a key management device according to the access request, where the authentication request includes the digital signature of the user cluster device, and acquiring an authentication result of the user cluster device returned by the key management device based on the authentication request.

According to an additional embodiment, a key management device for performing multi-user cluster identity authentication is disclosed. The device includes a main memory and a processor communicatively coupled to the main memory that distributes a key set and an identification code corresponding to the key to a user cluster device, where the key set includes pairs of public keys and private keys, acquires an authentication request, where the authentication request includes a digital signature of the user cluster device, performs identity authentication on the user cluster device using the digital signature, and returns an authentication result to a service device, where the digital signature includes an identification code of the user cluster device, and cluster verification information encrypted using the private keys.

### DESCRIPTION OF THE DRAWINGS

Other features, objectives and advantages of the present application will become more evident from a reading of the detailed description made to non-limited embodiments with reference to the following accompanying drawings:

FIG. 1 is a diagram of an exemplary system for performing multi-user cluster identity authentication depicted according to embodiments of the present invention;

FIG. 2 is a diagram of an exemplary key management device, an exemplary service device, and an exemplary user cluster device for supporting multi-user cluster identity authentication depicted according to embodiments of the present invention;

FIG. 3 is a diagram depicting an exemplary key management device, an exemplary service device and an exemplary user cluster device for supporting multi-user cluster identity authentication according to embodiments of the present invention;

FIG. 4 is a flow chart depicting an exemplary sequence of computer implemented steps for performing a method of multi-user cluster identity authentication according to embodiments of the present invention; and

FIG. 5 is a flow chart depicting an exemplary sequence of computer implemented steps for performing a method of multi-user cluster identity authentication according to embodiments of the present invention.

The same or similar reference signs in the drawings represent the same or similar components.

### DETAILED DESCRIPTION

The present application is further described below in detail with reference to the accompanying drawings.

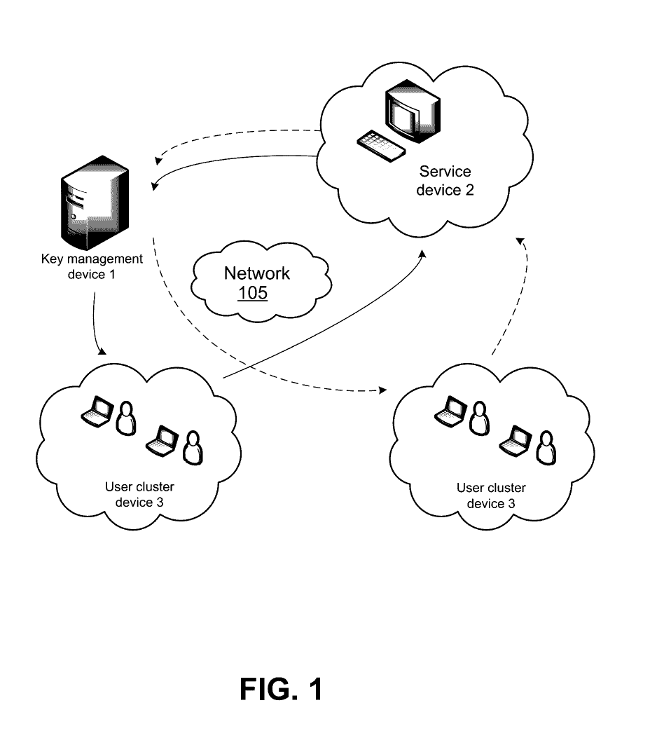

With regard to FIG. 1, a diagram of an exemplary system for performing multi-user cluster identity authentication is depicted according to embodiments of the present invention. The system includes a key management device 1, a plurality of service devices 2, and a plurality user cluster devices 3. The key management device 1 distributes keys (e.g., a key set or list of keys) and identification codes corresponding to the key set to the user cluster devices 3, when the user cluster devices 3 make a request to access the service devices 2, the service devices 2 sends to the key management device 1 an authentication request that includes digital signatures of the user cluster devices 3, the key management device 1 performs identity authentication on the user cluster devices 3, and returns an authentication result to the service devices 2.

The key management device 1 may be a network device, or a script/program executed on a network device. The service device 2 may include, but is not limited to, a user device, or a device formed by integrating a user device and a network device via a network service or a script/program run on a network device, and the user cluster device 3 may also include a user device, or a device formed by integrating a user device and a network device via a network service or a script/program run on a network device.

The user cluster device 3 refers generally to one or more devices in the same cluster, where the user cluster device 3 and the key management device 1 may be connected with each other via a network 105, and the service device 2 and the key management device 1 may be connected via the network 105, or located in the same network device. In addition, the service device 2 and the user cluster device 3 may also be connected via the network 105, or located in the same device cluster. One cluster device may serve as a service device to provide services for other user cluster devices, and may serve as a user cluster device to make a request for acquiring services from other service devices.

The network 105 may use, but is not limited to, WCDMA, CDMA2000, TD-SCDMA, GSM, CDMA1×, WIFI, WAPI, WiMax, an Ad Hoc network, etc. The network device may include an electronic device that can automatically perform numerical calculations and information processing using an instruction set, for example, and the components thereof may include, but are not limited to, a microprocessor, an application specific integrated circuit (ASIC), a field programmable gate array (FPGA), a digital signal processor (DSP), an embedded device, etc. The network 105 may include, but is not limited to, the Internet, a wide area network, a metropolitan area network, a local area network, a VPN network, an Ad Hoc network, etc. The network device may include a single server, or a plurality of servers connected via a local area network or the Internet. Furthermore, the network 105 may include a cloud consisting of a plurality of servers. The cloud may include of a large number of computers or network servers based on Cloud Computing, where Cloud Computing may comprise distributed computing that includes a virtual computer made up of a group of loosely coupled computer sets. The user device may include, but is not limited to, a mobile electronic device capable of carrying out human-computer interaction with a user through a touchpad, for example, a smartphone, a PDA and the like, and the mobile electronic device may use any operating system, for example, an android operating system, an iOS operating system, etc.

Those skilled in the art will understand that the aforementioned key management device 1, the service devices 2, and the user cluster devices 3, as well as networks, and communication modes, are merely for illustration; other instances of key management devices 1, service devices 2 and user cluster devices 3 may be used. Furthermore, those skilled in the art will understand that the key management device 1 may interact with multiple service devices 2 and multiple user cluster devices 3, distribute keys and identification codes for the user cluster devices 3, and receive an authentication request from one or more service devices 2 in real-time, and at the same time. Furthermore, the service device 2 may interact with multiple user cluster devices 3, initiate an authentication request to the key management device 1 according to an access request from the user cluster devices 3, and after obtaining an authentication result, provide a corresponding service for the user cluster devices 3 based on the authentication result.

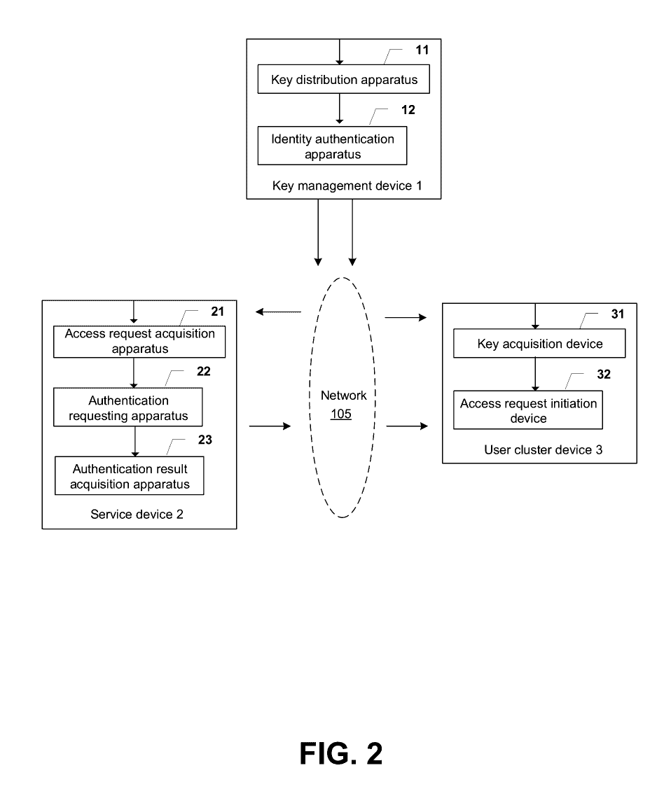

FIG. 2 depicts an exemplary key management device, an exemplary service device and an exemplary user cluster device for performing multi-user cluster identity authentication according to embodiments of the present invention. The key management device 1 includes: a key distribution apparatus 11 and an identity authentication apparatus 12. The service device 2 includes: an access request acquisition apparatus 21, an authentication requesting apparatus 22 and an authentication result acquisition apparatus 23. The user cluster device 3 includes a key acquisition apparatus 31 and an access request initiation apparatus 32.

The key distribution apparatus 11 distributes a key and an identification code corresponding to the key to a user cluster device, where the key includes public keys and private keys in pairs. The identity authentication apparatus 12 acquires an authentication request sent by the service device, performs identity authentication on the user cluster device based on a digital signature of the user cluster device in the authentication request, and returns an authentication result to the service device, where the digital signature includes an identification code of the user cluster device and cluster verification information encrypted using the private keys.

The access request acquisition apparatus 21 acquires an access request from a user cluster device, where the access request includes a digital signature of the user cluster device, and the digital signature includes an identification code of the user cluster device and cluster verification information encrypted using a private key. The authentication requesting apparatus 22 sends an authentication request to a key management device according to the access request, where the authentication request includes the digital signature of the user cluster device. The authentication result acquisition apparatus 23 acquires an authentication result of identity authentication on the user cluster device returned by the key management device.

The key acquisition apparatus 31 acquires a key set and an identification code corresponding to the key set sent by a key management device, the key set including public/private key pairs. The access request initiation apparatus 32 initiates an access request to a service device, where the access request includes a digital signature, and the digital signature includes the identification code and cluster verification information encrypted using the private keys.

When the key distribution device 11 distributes the key set for the user cluster device, an identification code (ID) that uniquely corresponds to the key is increased/incremented when the key is distributed. When the identity authentication apparatus 12 performs identity authentication, identity authentication may be performed on the user cluster device according to a digital signature having the identification code, so that multiple user cluster devices can be verified. Therefore, the service is provided for the multiple user cluster devices on the same service device.

The key distribution device 11 distributes a key set and an identification code corresponding to the key to a user cluster device, where the key set includes public/private key pairs.

There is a one-to-one relationship between the key and the identification code, where the corresponding key can be queried using the identification code. For example, a public key of the corresponding key is queried, the identification code may be a field of 16 bytes, and the identification codes (e.g., 0-2¹⁶) corresponding to the keys may be incrementally reused so that a single service device can provide services for 2¹⁶ user cluster devices.

The key distribution apparatus 11 distributes the key set to the corresponding user cluster device 3. Further, key distribution apparatus 11 distributes keys using a secure channel to avoid leakage of the signature and to increase efficiency when issuing keys.

The identity authentication apparatus 12 acquires an authentication request sent by the service device, performs identity authentication on the user cluster device based on a digital signature of the user cluster device in the authentication request, and returns an authentication result to the service device, where the digital signature includes an identification code of the user cluster device and cluster verification information encrypted using the private keys.

The cluster verification information may include: a cluster name, a cluster creation time, a creation time of the public keys and private keys, and an expiration time of the public keys and private keys, and other related information that can be used for verifying clusters may also be used as cluster verification information.

When the user cluster device makes a request to access a certain service device, the service device sends information related to the access request to the key management device 1 as an authentication request, and the key management device 1 performs identity authentication on the user cluster device. The identity authentication apparatus 12 of the key management device 1 searches for a public key of the user cluster device according to the identification code in the digital signature, decrypts the cluster verification information using the identified public key, and authenticates the cluster verification information.

In order to improve the authentication efficiency, the service device may create a list of public keys used for persistently storing user cluster devices, and the list of public keys is used for storing public keys and identification codes of user cluster devices that have made a request to access the service device. The authentication request of the service device acquired by the key management device 1 may further include the list of public keys of user cluster devices stored by the service device, and the identity authentication apparatus 12 may search for a public key corresponding to the identification code from the list of public keys using the identification code included in the digital signature in the access request, decrypt the cluster verification information using the identified public key, and authenticate the cluster verification information.

When the user cluster device makes a request to access the service device for the first time, or the key and the identification code of the user cluster device are updated, and the identity authentication apparatus 12 cannot find the corresponding identification code and public key from the list of public keys, the identity authentication apparatus 12 acquires a public key related to the corresponding identification code (e.g., the information reserved when the key distribution apparatus 11 distributes the key and the identification code), and performs identity authentication on the user cluster device using the public key. The identity authentication apparatus 12 sends the public key and the identification code of the user cluster device that does not exist in the list of public keys to the service device to be used by the user cluster device when making a request for access or performing identity authentication at a subsequent time, when the service device updates the public key and identification code into the list of public keys, thus improving the authentication efficiency.

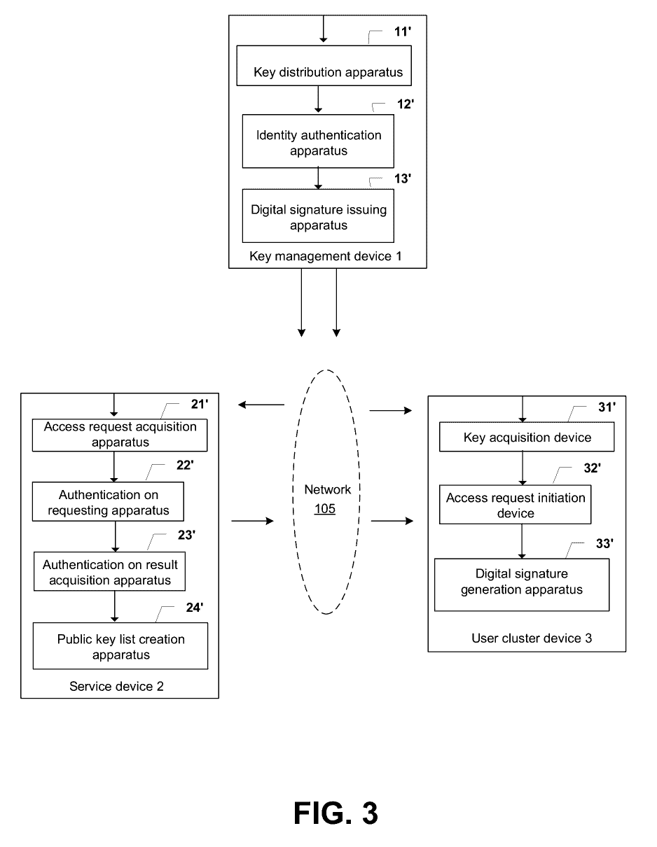

FIG. 3 depicts an exemplary key management device, an exemplary service device 2, and an exemplary user cluster device 3 for supporting multi-user cluster identity authentication, according to embodiments of the present invention. The key management device 1′ includes a key distribution apparatus 11′, an identity authentication apparatus 12′ and a digital signature issuing apparatus 13′. The key distribution apparatus 11′ distributes a key and an identification code using a polling mechanism, where the public key and private key pairs and the identification code are regularly updated. The updated key and identification code are distributed to the user cluster device, where the identification code is updated incrementally. The identity authentication apparatus 12′ is generally the same as the identity authentication apparatus 12 shown in FIG. 2. The digital signature issuing apparatus 13′ generates a digital signature for the corresponding user cluster device after the key and the identification code are updated using the updated key and identification code of a request from the user cluster device 3, and sends the generated digital signature to the user cluster device 3. According to some embodiments, the digital signature issuing apparatus 13′ sends the generated digital signature to the user cluster device 3 using a secure channel to enhance security. Each time the key distribution apparatus 11′ updates the key and the identification code, the digital signature issuing apparatus 13′ generates an updated digital signature based on to the updated key and the identification code, and the key polling mechanism causes the digital signature on the user cluster device to change as the key is changed, thus enhancing the security.

The service device 2′ includes: an access request acquisition apparatus 21′, an authentication requesting apparatus 22′, an authentication result acquisition apparatus 23′ and a public key list management apparatus 24′. The public key list management apparatus 24′ creates a list of public keys, and after the key management device returns an authentication result indicating that identity authentication on the user cluster device has passed authentication, acquires a public key and an identification code of the user cluster device that makes a request for access from the key management device. The public key list management apparatus 24′ stores the public key and the identification code in the list of public keys. The list of public keys includes a public key of the user cluster device 3′ that has accessed the service device 2′ and has been authenticated by the key management device 1′, and an identification code corresponding to the public key. The list of public keys may be persistently stored in a quorum directory (e.g., a processing directory). In the authentication request sent by the authentication requesting apparatus 22′ to the key management device, the authentication request further includes the list of public keys, and when the key management device 1′ performs identity authentication on the user cluster device 3′, the list of public keys may be used for decryption, thereby improving the authentication efficiency. The access request acquisition apparatus 21′ and the authentication result acquisition apparatus 23′ are generally the same as the access request acquisition apparatus 21 and the authentication result acquisition apparatus 23 shown in FIG. 2.

The user cluster device 3′ includes: a key acquisition apparatus 31′, an access request initiation apparatus 32′ and a digital signature generation apparatus 33′, where the digital signature generation apparatus 33′ is used for generating the digital signature according to the key and the identification code. The key and the identification code have a one-to-one relationship, and the corresponding key can be queried using the identification code, for example, using the public key of the corresponding key. Each time the key is updated, the corresponding identification code is updated incrementally. For example, each time a 16-byte field of the identification code having a value of 0-2¹⁶ is updated, the identification code is increased by one. The manner of increasing the identification code is not limited to successive increments, and may include a random increase, for example. Furthermore, when the identification code reaches a maximum value (e.g., 2¹⁶), the identification code may be updated and restart at 0.

The cluster verification information may include: a cluster name, a cluster creation time, a creation time of the public keys and private keys, and an expiration time of the public keys and private keys, and other related information that can be used for verifying clusters may also be used as cluster verification information.

According to some embodiments, the user cluster device 3 may allow the digital signature generation apparatus 33′ to generate the digital signature at the beginning of deployment, or may acquire an update from the digital signature issuing apparatus 13′.

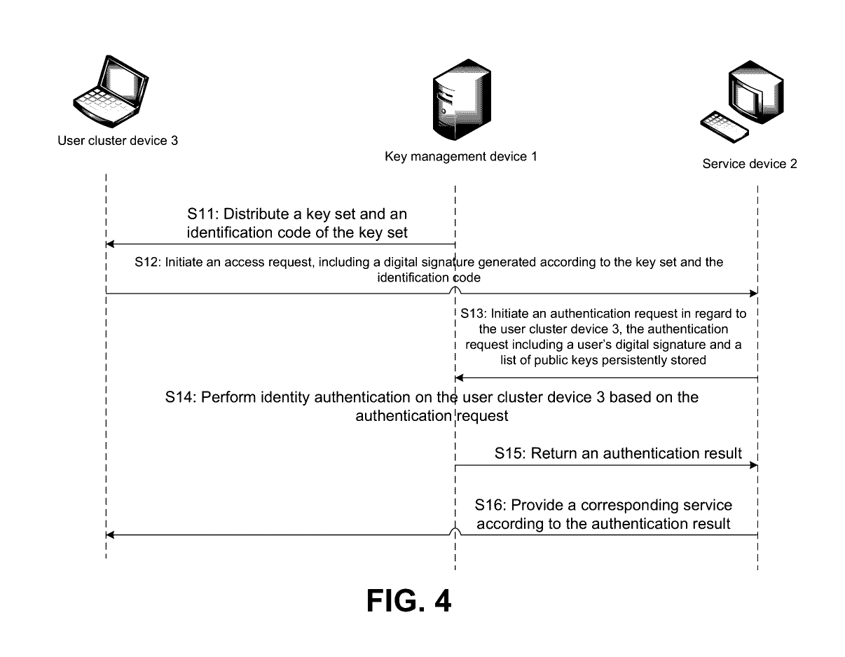

FIG. 4 depicts an exemplary sequence of computer implemented steps for performing a method of multi-user cluster identity authentication according to embodiments of the present invention.

Step S11 includes: distributing a key set and an identification code of the key set to a user cluster device, the key set including public/private key pairs;

step S12 includes: initiating an access request to a service device 2, where the access request includes a digital signature, and the digital signature includes the identification code and cluster verification information encrypted using a private key;

step S13 includes: sending an authentication request to the key management device 1 according to the access request, where the authentication request includes a digital signature of the user cluster device 3;

step S14 includes: acquiring the authentication request sent by the service device 2, and performing identity authentication on the user cluster device 3 based on the digital signature of the user cluster device 3 in the authentication request, using the key management device 1;

step S15 includes: returning an authentication result to the service device 2; and

step S16 includes: providing a corresponding service for the user cluster device 3 according to the authentication result.

In step S11, the key distribution apparatus 11 distributes the key to the corresponding user cluster device 3 on a secure channel, which avoids leakage of the signature, saves a key negotiation process, and improves key issuing efficiency. In step S14, when the key management device 1 performs identity authentication, the identity authentication may be performed on the user cluster device 3 according to a digital signature having the identification code, so that multiple user cluster devices 3 can be verified. In this way, the service is provided for the multiple user cluster devices 3 on the same service device 2.

According to some embodiments, the key and the identification code correspond one-to-one, and the corresponding key can be queried/located using the identification code. For example, when the public key of the corresponding key is queried, the identification code may be a field of 16 bytes, and then identification codes corresponding to all keys may be used incrementally in the range of 0-2¹⁶, such that a single service device can provide services for 2¹⁶ user cluster devices. The cluster verification information may include: a cluster name, a cluster creation time, a creation time of the public keys and private keys, and an expiration time of the public keys and private keys, and other related information that can be used for verifying clusters may also be used as the cluster verification information.

In step S14, the key management device 1 performs identity authentication on the user cluster device 3, and the key management device 1 searches for the public key of the user cluster device 3 according to the identification code in the digital signature, decrypts the cluster verification information using the identified public key, and authenticates the cluster verification information.

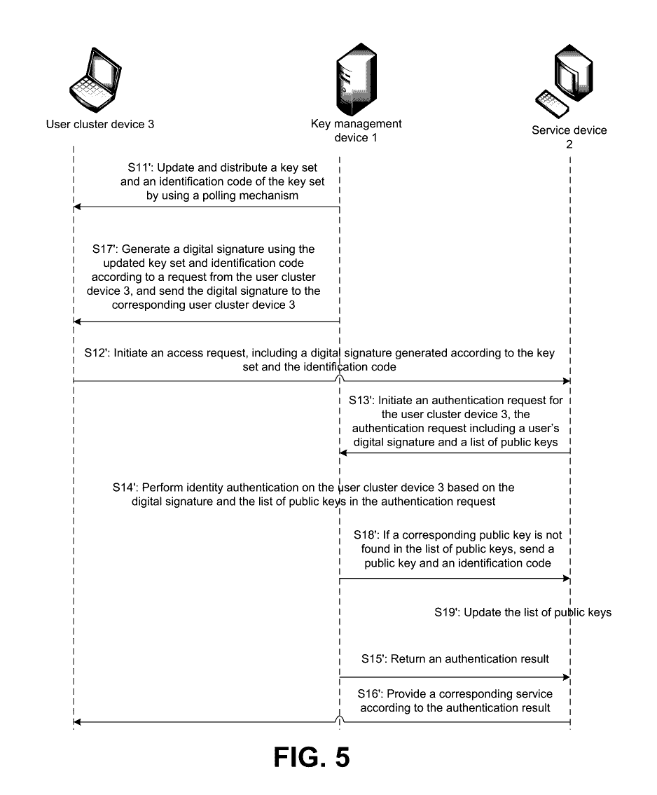

FIG. 5 depicts a method for verifying a user cluster device at a key management device end according to embodiments of the present invention.

Step S11′ is similar to step S11 shown in FIG. 3, where the key management device 1 distributes a key and an identification code using a polling mechanism. The public/private key pairs and the identification code are regularly updated and distributed to the user cluster device, where the identification code is updated incrementally on use.

In step S17′, the key management device 1 generates a digital signature for user cluster device 3 using the updated key and identification code, updates the generated digital signature, and sends the updated generated digital signature to the corresponding user cluster device 3. After the key and the identification code are updated, based on a request or call of the user cluster device 1, a digital signature is generated for the corresponding user cluster device using the updated key and identification code, and the generated digital signature is sent to the user cluster device. According to some embodiments, the key management device 1 sends the generated digital signature to the user cluster device 3, using the secure channel to enhance security. When the key and the identification code are updated in step S11′, in step S17′, an updated digital signature is generated according to the updated key and identification code, and the updated digital signature is sent to the user cluster device 3.

Step S12′ is the same as or basically the same as step S12 shown in FIG. 3, which, for simplicity, is incorporated herein by reference.

Step S13′ is similar to step S13 shown in FIG. 3. An authentication request is sent to the key management device 1′ according to the access request, where the authentication request includes a digital signature of the user cluster device 3′. The authentication request includes a list of public keys stored by the service device 2′. The list of public keys includes a public key of the user cluster device 3 that has accessed the service device 2′, and has been authenticated by the key management device 1′, and an identification code corresponding to the public key. According to some embodiments, the list of public keys is persistently stored in a quorum directory (e.g., a processing directory).

To increase the authentication efficiency, the service device may create a list of public keys, and store the list of public keys and identification codes of user cluster devices that have made a request to access the service device. The authentication request of the service device acquired by the key management device 1 may further include the list of public keys of user cluster devices persistently stored by the service device, and the list of public keys may be searched to find a public key corresponding to the identification code using the identification code of the digital signature in the access request. The cluster verification information may be decrypted using the identified public key to authenticate the cluster verification information.

According to some embodiments, when the user cluster device makes a request to access the service device for the first time, or the key and the identification code of the user cluster device are updated and the corresponding identification code and the public key cannot be found from the list of public keys, a public key corresponding to the identification code is acquired from stored information (e.g., the information reserved when the key and the identification code are distributed). Identity authentication is performed on the user cluster device using the public key. The public key and the identification code of the user cluster device that did not originally existing in the list of public keys are sent to the service device for use by the user cluster device when making a request for access and performing identity authentication the next time the service device updates the list of public keys.

Step S14′ is similar to step S14 shown in FIG. 3. A public key of the user cluster device 3 is identified from the list of public keys provided in step S13′ according to the identification code in the digital signature. More specifically, the identification code in the list of public keys is found according to the identification code in the digital signature, a corresponding public key is searched for according to the identification code found in the list of public keys, and if the corresponding public key is found from the list of public keys, the cluster verification information encrypted by the user cluster device 3 is decrypted by using the identified public key.

In addition, if the corresponding public key is found from the list of public keys, the user cluster device 3 has made a request for access, or the key and the identification code of the user cluster device 3 has been updated, the key management device 1 finds a public key corresponding the identification code from its own list of keys and identification codes, and decrypts the cluster verification information using the public key.

In step S18′, the public key and the identification code of the user cluster device 3 are sent to the service device 2.

In step S19′, the service device 2′ updates the public key and the identification code acquired into the list of public keys.

Step S15′ and step S16′ are generally the same as the contents of step S15 and step S16 shown in FIG. 3, which, for simplicity, are incorporated herein by reference.

According to some embodiments, a key set of a user cluster device is managed using a key management device, and a key and an identification code of the key set are issued to the user cluster device without requiring key negotiation. When the user cluster device makes a request to access a certain service device, the service device sends to the key management device an authentication request that includes a digital signature of the user cluster device, and the key management device performs identity authentication on the user cluster device.

Further, the key management device can regularly update the key set and the identification code of the key set using a polling mechanism, and distribute the key set and the identification code to the user cluster device. The user cluster device updates the digital signature using the updated key set and identification code, and security, including leakage risk, is improved.

Further, the service device can store public keys and identification codes of the key set in a persistent manner, to improve authentication efficiency.

It will be apparent to those skilled in the art that various modifications and variations can be made to the present application without departing from the spirit and scope of the present application. In this way, it is intended that the present application includes modifications and variations of the present application.

It should be noted that the present application can be implemented in software and/or a combination of software and hardware. For example, the present application can be implemented by using an application specific integrated circuit (ASIC), a general-purpose computer or any other similar hardware devices. According to some embodiments, the software program of the present application may be executed by a processor to implement the steps or functions stated hereinabove. Similarly, the software program (including related data structures) of the present application may be stored in a computer readable recording medium, for example, RAM memory, a magnetic or optical drive, or a floppy disk or similar device. In addition, some steps or functions of the present application can be implemented with hardware, for example, a circuit cooperating with the processor so as to execute respective steps or functions.

In addition, parts of the present application may be implemented as a computer program product, for example, a computer program instruction, and when the instruction is executed by a computer, the method and/or the technical solution according to the present application can be called or provided through operations of the computer. The program instruction that calls the method of the present application may be stored in a fixed or removable recording medium, and/or transmitted through broadcast or data streams in other signal carrying media, and/or stored in a working memory of a computer device that runs according to the program instruction. Some embodiments of the present application include an apparatus, and the apparatus includes a memory used for storing a computer program instruction and a processor used for executing the program instruction, wherein, when the computer program instruction is executed by the processor, the apparatus is triggered to run the methods and/or technical solutions based on multiple embodiments according to the present application.

For those skilled in the art, it is apparent that the present application is not limited to the details of the above exemplary embodiments, and without departing from the spirit or basic features of the present application, the present application can be implemented in other specific forms. Therefore, the embodiments should be regarded as exemplary and limitative from every point of view, and the scope of the present application is defined by the appended claims instead of the above description, and thus it is intended to include all changes falling within the meaning and range of equivalent elements of the claims into the present application. It is improper to regard any reference sign in the claims as a limitation to the claim involved. In addition, the wording “include” does not exclude other units or steps, and the singular form does not exclude the plural form. Multiple units or apparatuses stated in the apparatus claims may also be implemented by one unit or apparatus through software or hardware. Words such as first and second are used to represent names, but do not indicate any specific order.

What is claimed is:

1. A method of multi-user cluster identity authentication, the method comprising:
distributing a key set and an identification code corresponding to the key set to a user cluster device, wherein the key set comprises a plurality of pairs of a public key and a private key;
acquiring an authentication request sent by the service device;
performing identity authentication on the user cluster device based on a digital signature of the user cluster device in the authentication request; and
returning an authentication result to the service device,
wherein the digital signature comprises an identification code of the user cluster device, and cluster verification information encrypted using the private keys.

2. The method of claim 1, wherein the performing identity authentication on the user cluster device based on a digital signature of the user cluster device in the authentication request comprises:
searching for a fist public key of the user cluster device using the identification code in the digital signature;
decrypting the cluster verification information using the first public key; and
authenticating the cluster verification information.

3. The method of claim 2, wherein the authentication request further comprises:
a list of public keys of the user cluster device stored on the service device, the list of public keys comprising a second public key and a second identification code of the user cluster device, wherein the user cluster device has made an access request to access the service device, and wherein the performing identity authentication on the user cluster device based on a digital signature of the user cluster device in the authentication request comprises:
searching for the second public key of the user cluster device in the list of public keys according to the identification code in the digital signature, and decrypting the user cluster device using the second public key.

4. The method of claim 3, wherein the returning an authentication result to the service device further comprises sending the second public key and the second identification code of the user cluster device to the service device to update the list of public keys.

5. The method of claim 4, wherein the distributing a key set and an identification code corresponding to the key set to a user cluster device comprises:
updating the key set and the identification code; and
distributing the updated key set and identification code to the user cluster device, wherein the identification code is updated incrementally.

6. The method of claims 5, further comprising:
after the key set and the identification code are updated, generating a digital signature for a corresponding user cluster device using the updated key set and identification code in response to a request from the corresponding user cluster device; and
sending the generated digital signature to the corresponding user cluster device.

7. The method of claim 6, wherein the cluster verification information comprises at least one of: a cluster name, a cluster creation time, a creation time of the public keys and private keys, and an expiration time of the public keys and private keys.

8. The method of claim 7, wherein the key set and identification code are distributed using a secure channel.

9. A method of multi-user cluster identity authentication, the method comprising:
acquiring an access request from a user cluster device, wherein the access request comprises a digital signature of the user cluster device, the digital signature comprises an identification code, and cluster verification information encrypted using a private key;
sending an authentication request to a key management device according to the access request, wherein the authentication request comprises the digital signature of the user cluster device; and
acquiring an authentication result of the user cluster device returned by the key management device based on the authentication request.

10. The method of claim 9, further comprising:
creating a list of public keys;
after the authentication result is acquired, acquiring a first public key and a first identification code of a first user cluster device, wherein the first user cluster device made a request for access using the key management device; and
storing the first public key and the first identification code in the list of public keys.

11. A key management device for performing multi-user cluster identity authentication, the device comprising:
a main memory; and
a processor communicatively coupled to the main memory that distributes a key set and an identification code corresponding to the key to a user cluster device, wherein the key set comprises a plurality of pairs of a public key and a private key, acquires an authentication request, wherein the authentication request comprises a digital signature of the user cluster device, performs identity authentication on the user cluster device using the digital signature, and returns an authentication result to a service device, wherein the digital signature comprises an identification code of the user cluster device, and cluster verification information encrypted using the private keys.

12. The key management device of claim 11, wherein the processor searches for a first public key of the user cluster device according to the identification code in the digital signature, decrypts the cluster verification information using the first public key, and authenticates the cluster verification information.

13. The key management device of claim 12, wherein the authentication request further comprises: a list of public keys of the user cluster device, wherein the list of public keys comprises a second public key and a second identification code of a second user cluster device, wherein the second user cluster device has made a request to access the service device, and wherein the processor searches for the second public key of the second user cluster device in the list of public keys according to the identification code in the digital signature, and decrypts the second user cluster device using the first public key.

14. The key management device of claim 13, wherein the processor sends the second public key and the second identification code of the second user cluster device to the service device, and the service devices updates the list of public keys using the second public key and the second identification code.

15. The key management device of claim 14, wherein the processor updates the second key and the second identification code, and distributes the second key and the second identification code to the second user cluster device, wherein the identification code is updated incrementally.

16. The key management device of claim 15, wherein the processor generates a digital signature for the second user cluster device using the second key and the second identification code according to a second request from the second user cluster device, and sends the generated digital signature to the second user cluster device.

17. The key management device of claim 16, wherein the cluster verification information comprises at least one of: a cluster name, a cluster creation time, a creation time of the public keys and private keys, and an expiration time of the public keys and private keys.

18. The key management device of claim 17, wherein the processor distributes the key set and the identification code using a secure channel.
